(19) United States
(12) Patent Application Publication
(10) Pub. No.: US 2001/0000478 A1
(43) Pub. Date: Apr. 26, 2001

(54) Process for manufacturing sheets or plates having a lenticular dot or line decoration in plastic and/or paint: device and product

(76) Inventor: Marco Calvanella, Piegaro (PG) (IT)

Correspondence Address: Douglas W. Swartz, SHERIDAN ROSS P.C., Suite 1200, 1560 Broadway, Denver, CO, 80202-5141, US

(21) Appl. No.: 09/730,357

(22) Filed: Dec. 4, 2000

Related U.S. Application Data
(62) Division of application No. 09/023,648, filed on Feb. 2, 1998, now Pat. No. 6,185,892.

(30) Foreign Application Priority Data
Feb. 14, 1997 (IT) MI97A000317

(51) Int. Cl. B32B 3/10; A47G 1/00; E04C 2/54; B05D 5/00

(52) U.S. Cl. 428/14; 428/; 428/195; 52/311.1; 52/785.1; 427/256; 427/287

(57) ABSTRACT

On a sheet of plastic material or plate of glass, transparent or translucent, colored or otherwise, decorations in paint or plastic material, in the form of lenticular dots or flat dots or lines are applied by means of a “cliché” provided with conical points or ridge shapes, previously immersed in a paint or plastic and then applied to the sheet or plate. A plurality of sheets thus decorated can be assembled with or without distance pieces and set in a frame, to form a decorative panel.

### DESCRIPTION

1. The object of the present application is to obtain a new product for ornamental use and interior decoration, in a practical, rapid manner that can be applied industrially.

2. The subject matter the invention is a process as stated in claim 1. A product as stated in claim 6 or 7 and a device to carry out the process, as stated in claim 11, also form the subject matter of the invention.

3. According to the new process, a base plate or sheet of transparent or translucent plastic material or glass is prepared, for example a sheet of rigid polymethylmetacrylate (Plexiglas) or of flexible polyester, preferably 76 or 100 μm thick. Dots or areas of paint are then applied to said sheet, using, for example, a so-called nitrosynthetic paint, preferably transparent and colored, and allowed to dry. The paint is applied using a board with pointed projections in a punctiform or linear pattern, which will hereafter be called the “cliche”. The cliche is partially immersed in a tank containing the paint or plastic, then raised and lowered onto the base sheet. The cliche is them raised and the sheet with the application is allowed to dry. The sheet with the decoration can then be used alone, or incorporated into a panel with transparent surfaces, or else incorporated into a panel with a mirror surface facing the sheet; or otherwise a plurality of sheets, preferably with a different arrangement of the applications, can be assembled to form a panel. The sheet and the panel constitute new products. The process and the device make it possible to obtain the product industrially, in a practical and economical manner.

4. An exemplary embodiment will be described hereunder with reference to the attached drawings in which:

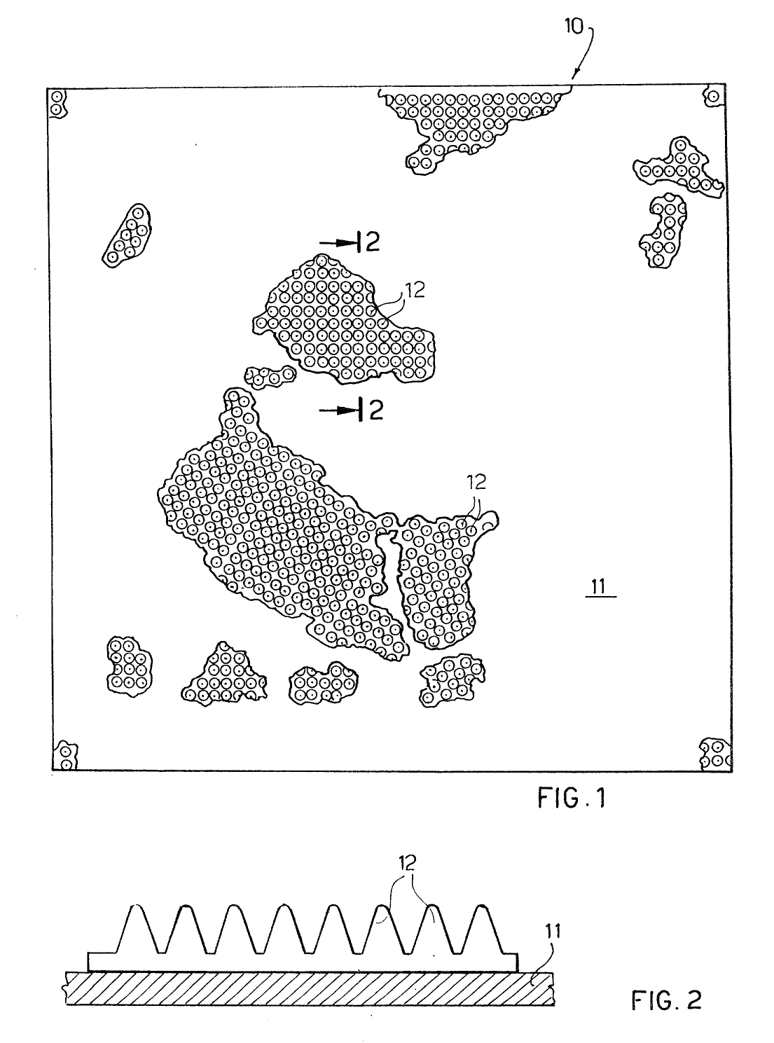

5. FIG. 1 is a front view of a first embodiment of a device, or “cliche”, used for the process;

6. FIG. 2 is an enlarged sectional view taken along a plane indicated by 2-2 in FIG. 1;

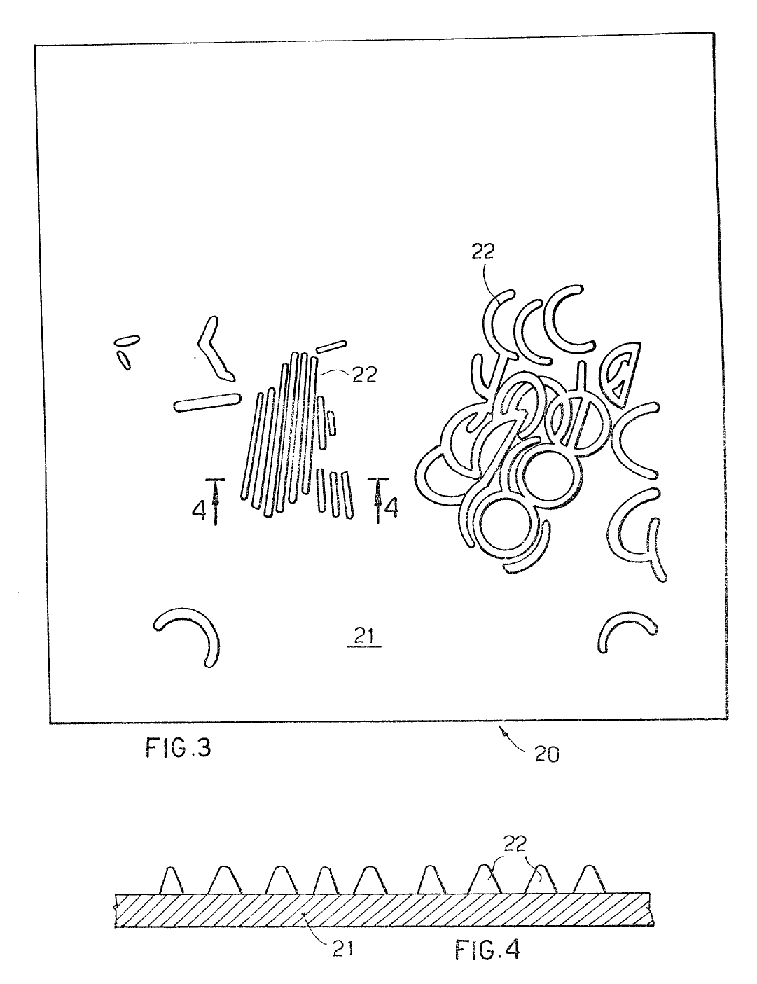

7. FIG. 3 is a front view of a second embodiment of the device or “cliche” used for the process;

8. FIG. 4 is an enlarged sectional view taken along a plane indicated by 4-4 in FIG. 3,;

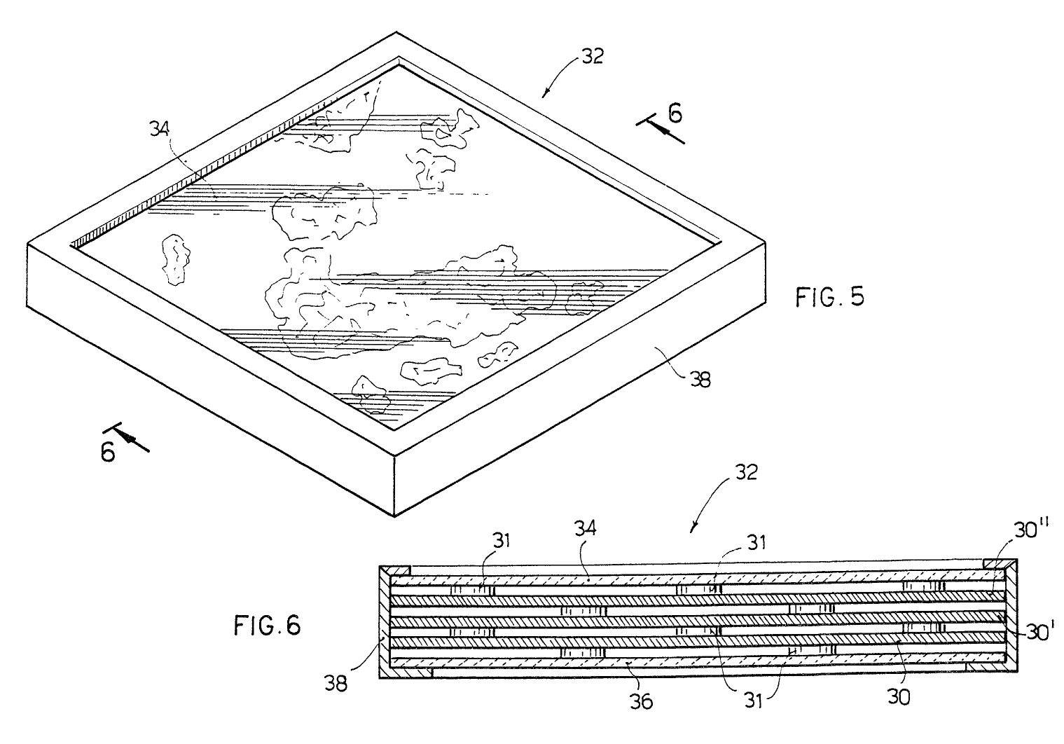

9. FIG. 5 is a perspective view of a panel obtained by the process of the invention;

10. FIG. 6 is a sectional view taken along a plane indicated by 6-6 in FIG. 5;

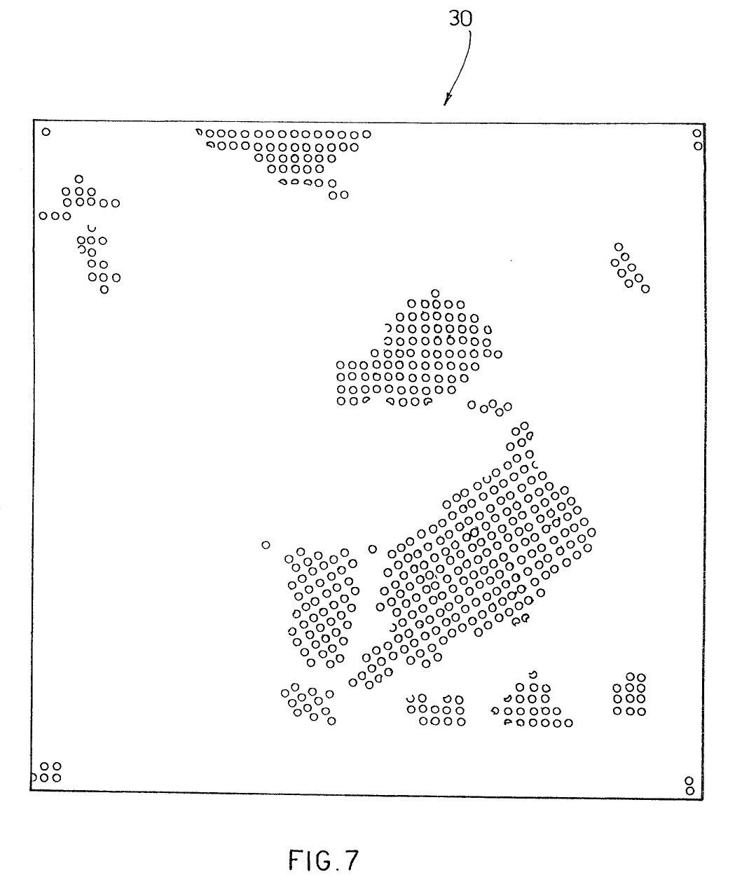

11. FIG. 7 is a view of a sheet product obtained.

12. Some embodiments of devices or cliches used for the process will first be described.

13. The cliché referenced 10 in FIG. 1 comprises a stiff base board 11 on which are applied conical or in any case tapered points or portions referenced 12, with chamfered tips. The points 12 can be part of a sheet of material 13 thus obtained, as in the example in FIG. 2; or else they can be made up of nails or the like applied at suitable points of the base board.

14. A cliché 20 shown in FIG. 3 comprises a plurality of linear portions with a tapered cross section, referenced 22, applied to a base board 21. The linear portions can have any shape, for example they can extend in a straight line, or in a semi-circle or according to any desired curve. It is also possible to obtain clichés with tapered punctiform or linear shapes on the same table.

15. According to the process of the invention, a cliché 10 or 20 or of any kind desired is lowered onto a tank containing liquid or semiliquid printing material (not shown). What is meant by printing material in this context is a paint or plastic material; nitrosynthetic paints or any synthetic resin that can be colored can be used: polyesters, polyurethanes, epoxy materials, UV adhesives for glass.

16. The cliché is dipped in the liquid contained in the tank so as to bathe only the points 12 and/or 22, then it is raised and translated onto the vertical of a base sheet or plate of transparent plastic material onto which it is lowered. Alternatively the base sheet of plastic material can be moved with respect to the cliché.

17. The cliché is then raised again and brought back onto the vertical of the tank for a subsequent cycle. The base sheets with the application of paint or plastic are then allowed to dry or dried. The sheets 30 (FIG. 7) thus provided with the application can be used as an end product for decoration or furnishing, or they can be made into panels by combining them with a frame and, for example, a mirror back board and a transparent protective board. Alternatively, the invention also provides for a panel 32 (FIGS. 5 and 6) comprising a combination of decorated sheets 30, 30′, 30′ (possibly spaced out from each other by distance pieces 31 consisting, for example, of small circles or hollow cylinders or other shape of transparent plastic), and transparent boards 34 on both faces in contact with the outside or on at least one of them, whilst the other can have a mirror board, 36; the whole being assembled by means of a frame 38.

Claims

1. A process for manufacturing a decorated sheet or plate, comprising the following steps:
a) preparing a base sheet or plate of plastic material or glass
b) applying decorations in liquid or semiliquid material to said sheet or plate;
c) allowing said decorations to dry on the base sheet or plate.

2. A process according to claim 1 wherein said base sheet or plate comprises a material chosen among polyester, glass, polycarbonate, polymethylmethacrylate.

3. A process according to claim 1 wherein the decoration material is chosen among the following:
nitrosynthetic paints; polyesters; polyurethanes; epoxy resins; UV adhesives for glass and the like.

4. A process according to claim 1, wherein for the steps of applying decorations a board provided with tapered parts (12; 22) in a punctiform or linear pattern is used.

5. A process according to claim 4 wherein the applying steps (b) comprises the steps of:
d) lowering said cliché onto a tank containing said decoration printing material,
e) raising said cliché from the tank;
f) lowering the cliché with the printing material carried by the tapered parts onto the base sheet or plate;
g) raising said cliché from the base sheet or plate.

6. A panel comprising at least one sheet obtained by a process according to any claim from 1 to 5.

7. A panel of plastic or glass material characterized in that it comprises a base sheet or plate (30) of transparent or translucent plastic or glass material and applications in printing material with a linear or lenticular or punctiform shape.

8. A panel according to claim 7, characterized in that it further comprises a transparent protective board (34) and a frame (38).

9. A panel according to claim 8, characterized in that it comprises a mirror board (36).

10. A panel according to claim 8, characterized in that it comprises a plurality of such sheets or plates (30, 30′, 30″) spaced out from each other by means of distance pieces (31).

11. A device for carrying out the process according to any one of claims 1 to 5, comprising a board (11; 21) with tapered elements (12; 22) protruding form one face, at least in some areas thereof that must perform the application steps.

12. A device according to claim 11 wherein said elements comprise punctiform elements (12) and/or straight and/or curved linear elements (22).
